(19) United States
(12) Patent Application Publication
(10) Pub. No.: US 2014/0307871 A1
(43) Pub. Date: Oct. 16, 2014

(54) METHOD FOR KEY ESTABLISHMENT USING ANTI-COLLISION ALGORITHM

(71) Applicant: Electronics and Telecommunications Research Institute, Daejeon (KR)

(72) Inventors: Yousung KANG, Daejeon (KR); Doo Ho CHOI, Daejeon (KR)

(21) Appl. No.: 13/935,507

(22) Filed: Jul. 4, 2013

(30) Foreign Application Priority Data
Apr. 15, 2013 (KR) 10-2013-0040891

(51) Int. Cl. H04L 9/08; G06K 7/10

(52) U.S. Cl. CPC H04L 9/0816; G06K 7/10019
USPC 380/270; 380/44

(57) ABSTRACT

A method for a key establishment in RFID system using an adaptive Q anti-collision algorithm, the method comprising:generating group key between a reader and a number of tags using values of Q that are changed under the adaptive Q anti-collision algorithm; and creating session keys between the reader and the tags using unique IDs of the respective tags.

### RELATED APPLICATIONS

This application claims the benefit of Korean Patent Application No. 10-2012-0040891, filed on Apr. 15, 2013, which is hereby incorporated by reference as if fully set forth herein.

### FIELD OF THE INVENTION

The present invention relates to a key establishment in an RFID (Radio Frequency Identification) system, and more particularly, to a method for an efficient key establishment using an anti-collision algorithm for a passive RFID reader and tags that are operated in 900 MHz UHF band.

### BACKGROUND OF THE INVENTION

An RFID technique, which has been advanced and developed in magnetic card systems and bar code systems, is a technique that recognizes wirelessly, tracks and identifies people, goods, and animals. An RFID system is composed of tags, a reader (or an interrogator) and a host computer that is able to process the data read from the tags. Data communication between the reader and the tags is done by a wireless communication system.

A tag incorporates therein a memory for storing data, an IC circuit, a microprocessor and an antenna and is classified into an active tag and a passive tag depending on the presence or absence of an energy source within the tag. As for the active tag, because it has a power supply of its own, recognition is possible at a distance far beyond compared to the passive tag that is powered by induction currents in the reader. The reader continuously radiates radio waves via its antenna. When the tag in which an ID and data are saved therein comes within range of the radio waves, it transmits the ID and data to the antenna of the reader. At this time, the reader converts the ID transmitted from the tag into a data signal and sends it to the host computer. The host computer compares the converted ID of the data signal to an ID stored previously in a database, to thereby provide a required service.

When the RFID system is classified accord in to transmission frequency, it is divided into systems for a low frequency band (100˜500 kHz), a high frequency band (10˜15 MHz) and an ultra-high frequency band (860˜960 MHz, 2.4˜5.3 GHz). In connection with the RFID International Standardization of the ultra-high frequency band, in recent years, standard Type A, Type B and Type C were adopted as a standard by 18000-6 (860˜960 MHz band wireless access standard) from the ISO/IEC JTC1 SC31 WG4. The ISO/IEC 18000-6 Type C standard is a standard that is applied to the passive REID reader and tags in 900 MHz UHF band.

The REID reader and tags also require security techniques to perform mutual authentication and to protect data transfer as common digital communication devices. Specially, the key establishment between the tags and the REID reader is also one of the core technologies.

A typical key establishment technology in the REID system is based on traditional methods primarily, and representative techniques include a key exchange using a public key infrastructure, a key distribution by a trustworthy third party, a pre-key establishment that stores keys in advance in the tags and the reader and the like.

These techniques operate at an Application layer, for example, the highest layer in light of OSI (Open System Interconnection) 7 Layer and thus additionally require a key exchange procedure between the tags and the reader apart from a primary communication protocol. Therefore, if the key establishment is derived from the communication protocol of the lower layer, for example, an L2 data link layer or L1 physical layer in light of the OSI 7 layer, the separate key exchange procedure is no longer necessary additionally, which may lead to an increase of key exchange efficiency.

### SUMMARY OF THE INVENTION

In view of the above, the present invention provides a method for an efficient group key establishment using an anti-collision algorithm of an L2 data link layer, without a separate additional key exchange procedure between a passive reader and tags that are operated in a UHF (Ultra-High Frequency) band.

Further, the present invention provides a method for a secure session key establishment on a basis of the group key established using an anti-collision algorithm of an L2 data link layer, without a separate additional key exchange procedure between a passive reader and tags that are operated in a UHF band.

In accordance with an exemplary embodiment of the present invention, there is provided a method for a key establishment in RFID system using an adaptive Q anti-collision algorithm, the method comprising: generating group key between a reader and a number of tags using values of Q that are changed under the adaptive Q anti-collision algorithm; and creating session keys between the reader and the tags using unique IDs of the respective tags.

In the exemplary embodiment, wherein said generating a group key comprises: concatenating the values of Q to produce concatenated bit streams; and hashing the concatenated bit streams to generate the group key.

In the exemplary embodiment, wherein said creating session keys comprises: performing an encryption operation on the unique IDs wherein the group key is used as an encryption key.

In the exemplary embodiment, wherein the group key and the session keys are updated and generated every inventory round.

In the exemplary embodiment, wherein the RFID system is a passive RFID system that uses a 900 MHz frequency band.

In the exemplary embodiment, wherein the group key is generated in an L2 data link layer.

In the exemplary embodiment, wherein the session keys are generated in an L2 data link layer.

As described above, the group key establishment method in accordance with the embodiment of the present invention uses the concatenated bit streams of random Q values generated by the anti-collision algorithm of an L2 data link layer. Therefore, an efficient group key establishment is provided without a separate key exchange protocol required in the conventional key establishment methods.

Further, the group key establishment method of the embodiment of the present invention renders the number of the query command and Q values to vary in compliance with the adjustment factor c of the reader and the situation of a wireless link related with the response pattern of the tags. Therefore, the group key generated by help of the embodiment of the invention is also generated randomly. In other words, it is possible to generate the group key that exhibits a random property of a superior quality and that has scarcely any collision possibility between the group keys generated in the inventories different from each other.

### BRIEF DESCRIPTION OF THE DRAWINGS

The above and other objects and features of the present invention will become apparent from the following description of the embodiments given in conjunction with the accompanying drawings, in which:

FIG. 1 is a schematic block diagram of a passive RFID system at 900 MHz UHF to which an embodiment of the present invention is applied;

FIG. 2 is a flowchart illustrating an adaptive Q anti-collision algorithm used in a passive RFID system at 900 MHz UHF in accordance with an embodiment of the present invention; and

FIG. 3 is a flowchart illustrating a process of establishing group key and session keys in accordance with an embodiment of the present invention.

### DETAILED DESCRIPTION OF THE EMBODIMENTS

Hereinafter, the embodiments of the present invention will be described in detail with reference to the accompanying drawings so that a person having an ordinary skill in the art can easily implement the embodiments of the present invention.

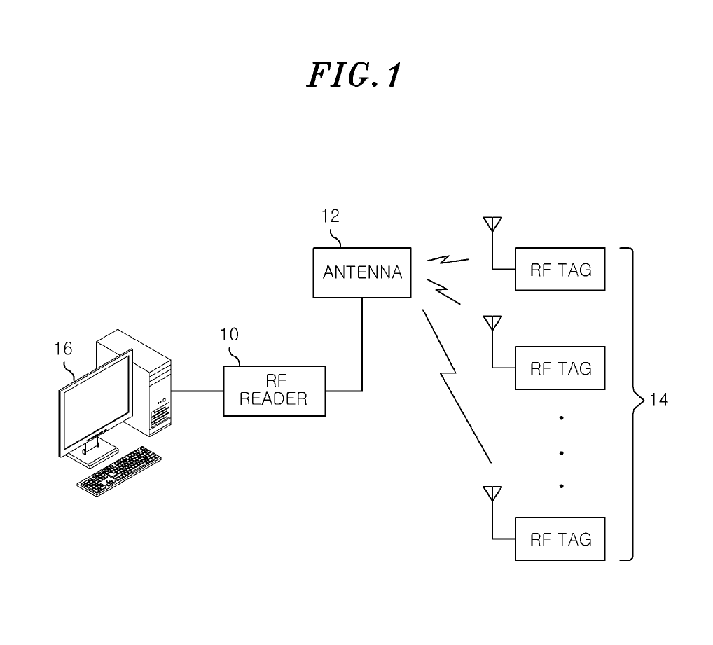

FIG. 1 is a schematic block diagram of a passive RFID system at 900 MHz UHF to which an embodiment of the present invention is applied. The RFID system to which the embodiment of the present invention is applied is a passive RFID system that uses a 900 MHz UHF band defined in the ISO/IEC 18000-6 standard.

Referring to FIG. 1, the RFID system that operates in the 900 MHz UHF band includes a reader 10, an RF tag group composed of a plurality of RF tags 14 and a host computer 16. The RF tags 14 access the reader 10 at the same time in a multiple access scheme.

The reader 10 continuously transmits query commands to the tags 14 via its antenna 12. When the reader 10 transmits a query command, it incorporates a value of Q into the query command to transmit it to the tags 14. Each of the tags 14, which receives the query command, arbitrarily chooses a value between 0 and 2^{Q}−1 to settle it in a slot-counter (SC). After that, only the tag that has the slot-counter of 0 (zero) replies. In this case, the reader 10 maintains the value of Q. When none of the tags have the slot-counter of 0, the tags remain silent, that is, no reply is received from any tags 14. In this case, the reader 10 decreases or maintains the value of Q. Meanwhile, when there are more than one slot-counter having 0, corresponding several tags 14 reply. This situation corresponds to a collision reply event and the reader 10 cannot receive the replies from the tags. In this collision reply event, the reader 10 changes the value of Q by increasing the value of Q or remains the value of Q.

After the transmission of a Query command at first, the reader 10 again transmits a QueryRep command or a QueryAdjust command to the tags 14 via the antenna 12. If the value of Q is changed (that is, if the value of Q decreases or increases), the reader 10 transmits the QueryAdjust command including the changed value of Q. The Tags 14, which receive the QueryAdjust command, again generate slot-counters having arbitrarily values between 0 and 2^{Q}−1 based on the changed value of Q. If the value of Q in the reader 10 is not changed in a no-reply event in which none of the tag reply, the reader 10 transmits the QueryRep command and the tags 14, which receive the QueryRep command, decrease their slot-counters by 1. The Tags 14, which receive the QueryRep command or the QueryAdjust command, continue to repeat a situation of a normal reply (to maintain the value of Q), no-reply (to decrease the value of Q or maintain the value of Q), and collision (to increase the value of Q or maintain the value of Q).

As described above, when there are several tags within a reading range of the reader, several tags reply at one time in response to the request from the reader. At this time, the replies from the several tags cause mutual interference to make a collision. Therefore, a method is needed to solve the mutual interference between the reply signals from the tags and to recognize the reply signals without the collision, which is called an anti-collision algorithm.

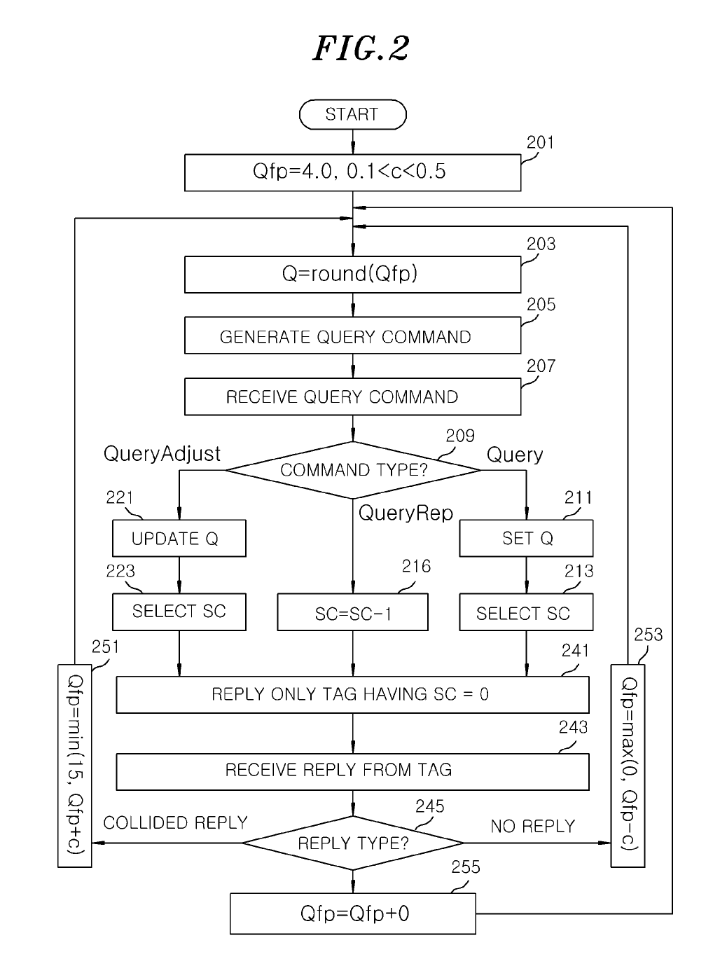

FIG. 2 is a flow chart illustrating an adaptive Q anti-collision algorithm which is the anti-collision algorithm of the L2 data link layer used in a passive RFID system at 900 MHz UHF in accordance with an embodiment of the present invention.

The adaptive Q anti-collision algorithm employs three query commands, that is, Query, QueryAdjust, and QueryRep commands. When one reader 10 sends these commands to the multiple tags 14, the respective tags 14 reply or do no-reply (or silent) under the adaptive Q anti-collision algorithm. From the standpoint of the reader, therefore, three types of reply situation are recognized in a wireless link, that is, a collided reply, no reply and successful reply. To put it another way, it means that two or more tags replied, none of the tags replied, or only one tag replied.

The most important key role of the adaptive Q anti-collision algorithm is the value of Q that affects the selection of the slot-counter. When the reader 10 transmits a query command, it transmits the query command along with the value of Q, and each tag 14, which receives the query command, calculates 2^{Q} and chooses arbitrarily one of values between 0 and 2^{Q}−1 to settle it in the slot-counter. The tags 14 having only a slot-counter of 0 transmit a reply message via the wireless link.

The value of Q is expressed by 4 bits, which have values of 0 to 15. The value of Q is incorporated in a Query and QueryAdjust command among the query commands, and each tag that receives these commands always newly select the slot-counter between 0 and 2^{Q}−1. The QueryRep command does not incorporate the value of Q, and thus, each tag 14 that receives the QueryRep command does not select a new slot-counter, but decreases the slot-counter by 1.

The reader 10 puts into operation the adaptive Q anti-collision algorithm in order to change the value of Q adaptively in accordance with the reply event. In FIG. 2, Qfp denotes a floating-point representation of the value of Q, SC denotes the slot-counter and c denotes an adjustment factor to adjust the Qfp. An actual value of Q that the reader 10 uses in query commands is defined as the rounded off value of Qfp, i.e., round(Qfp).

The adaptive Q anti-collision algorithm will be described with reference to FIG. 2 in detail.

The reader 10 firstly sets a value of Qfp having a floating-point data type and transmits the Query command to the tags 14 via the antenna 12, in operation 201. The value of Q is set to be a value of 4 and the adjustment factor c has a value between 0.1 and 0.5.

The actual value of Q that the reader 10 uses in the query commands is defined as a value that rounds off Qfp, i.e., round(Qfp), in operation 203.

The reader 10 generates a query command and transmits the query command via the antenna 12, in operation 205, and the tags 14 receive the query command, in operation 207.

A type of the query command received by the tags 14 may be the Query command, the QueryAdjust command and the QueryRep command as indicated in following operation 209.

The operations performed in the tags 14 are different in compliance with the type of these commands.

For the Query command, each tag 14 calculates 2^{Q} using a new value of Q, which is incorporated in the Query command received from the reader 10, to choose arbitrarily one value between 0 and 2^{Q}−1 in in operation 211, and settle it in the slot-counter, in operation 213.

For the QueryAdjust command, each tag 14, which receives the QueryAdjust command, updates the Q, in operation 221, and chooses arbitrarily one value between 0 and 2^{Q}−1 to settle it in the slot-counter, in operation 223.

For the QueryRep command, since the value of Q is not included in the QueryRep command, the tags 14 that receive the QueryRep command do not select the slot-counters newly but decreases the slot-counters by 1, in operation 216.

Subsequently, only the tags 14 whose the slot-counter has 0 reply, in operation 241, and the reader 10 receives the replies, in operation 243.

In operation 245, the reader 10 determines whether the type of the replies is a collided reply, no reply, or successful reply event.

The collided reply event refers to a situation where two or more tags 14 among a plurality of tags choose a slot-counter of 0, and the method goes to operation 251. In operation 251, Qfp increases by c, and the Qfp is set to 15 (i.e., Qfp=min(15, Qfp+c)) if the increased Qfp exceeds 15. Here, the value of Q has a value of an integer number that rounds off the Qfp (i.e., Q=round(Qfp).

The no reply event refers to a situation where none of the tags 14 have the slot-counter of 0, and the method advances to operation 253. In operation 253, under the adaptive Q anti-collision algorithm, the Qfp decreases by c, and the Qfp is set to 0 (i.e., Qfp=max(0, Qfp−c) if the decreased Qfp becomes a negative number. Similarly, the value of Q has a value of an integer number that rounds off the Qfp (i.e., Q=round(Qfp).

The successful reply event refers to a situation where only one tag 14 chooses the slot-counter of 0, and the method proceeds to operation 255. In operation 255, the Qfp and the Q remain as they are. That is, Qfp=Qfp+0.

The tags 14 that receive the QueryRep command or the QueryAdjust command continue to repeat the successful reply (to maintain the Qfp), the no reply (to decrease Qfp by c) or the collided reply (to increase Qfp by c)

In the adaptive Q anti-collision algorithm, an initial value of Q is defined as a value of 4, the adjustment factor c is defined to have a value between 0.1 and 0.5. Therefore, because the value of Q is an integer number between 0 and 15, and the value of the adjustment factor c is less than 1, the change in the value of Q after the three events in the adaptive Q anti-collision algorithm is one of the three cases, i.e., an increase by 1, a decrease by 1 or no change.

The reader 10 sends the value of Q that has been changed under the adaptive Q anti-collision algorithm to the tags 14 in compliance with the following rules.

First, for the collided reply, the reader 10 incorporates a value of Q=round(Qfp+c) in the QueryAdjust command and transmits the same to the tags 14.

Second, for the no reply, if the value of Q has been changed (i.e., a value of round(Qfp−c) has decreased by 1 than a previous value of Q), the reader 10 incorporates the value of Q that has been changed in the QueryAdjust command and transmits the same to the tags 14. However, if the value of Q has not changed (i.e., a value of round(Qfp−c) is the same as a previous the value of Q), the reader 10 transmits the QueryRep command to the tags 14.

Finally, for the successful reply, the reader 10 incorporates the same value of Q as a previous one in the QueryAdjust command and transmits the same to the tags 14.

Because the tags 14 reply randomly under the adaptive Q anti-collision algorithm, the event such as the collided reply, the no reply or the successful reply happens randomly and thus the reader 10 renders the value of Q to increase by 1, decrease by 1, or to be no change randomly.

A procedure that a reader 10 communicates with the tags 14 within its interrogation range to read IDs of the tags 14 is referred to as an inventory round. During one inventory round, the tags 14 will make the events in the wireless link randomly, and thus the reader 10 will repeatedly transmit the QueryAdjust command or the QueryRep command to the tags 14. The value of Q that the tags 14 need to consider to choose the slot-counter will be changed with an increase by 1, an decrease by 1, or no change randomly in accordance with the events in the wireless link and the effect of the adjustment factor c. That is, it is noted that the number of query commands to be repeated until one inventory round is over does not always constant. In other words, when it is assumed that the inventory round is performed several times, the number of the query commands is not constant every time, and the change in the value of Q will be also changed for each inventory round. Even though the query commands in any twice inventory rounds are equal in the number, a probability that the changes in the values of Q are equal to each other is extremely rare because the events pattern in the wireless link and a value of the adjustment factor c must be always equal to each other.

In view of the above, the embodiment of the present invention provides a method in which the reader 10 and the tags 14 establish a group key and session keys using the property in the adaptive Q anti-collision algorithm of the L2 layer.

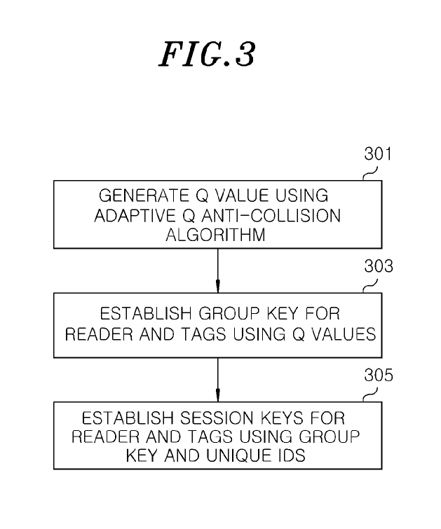

FIG. 3 is a flowchart illustrating a process of establishing a group key and session keys between the reader and the tags in accordance with an embodiment of the present invention.

The embodiment of the present invention establishes a group key using the adaptive Q anti-collision algorithm of the L2 layer and session keys using the group key and unique ID information.

The establishment of the group key and the session keys is conducted along with the procedure of generating the query commands performed in operation 203 of FIG. 2.

Following notations are used to explain the embodiment of the present invention.

q Current value of Q, (0=Qmin≦q≦Qmax=15)

N Total number of tags

t Current index of a tag, (1≦t≦N)

R Total number of inventory rounds

i Current index of inventory round, (1≦i≦R)

Y Total number of query commands

j Current index of query command, (1≦j≦Y)

G Group key

S Session key

∥ Bit concatenation

H Cryptographic hash function, (e.g., SHA-1)

Ek Cryptographic encryption function, (e.g., AES-128) (where k denotes an encryption key)

First of all, in operation 301, a value of Q is generated using the adaptive Q anti-collision algorithm.

In operation 303, a group key for the reader 10 and the tags 14 is generated every inventory round in accordance with the change in the value of Q using a following Equation 1.

G_{i(N)}=H(q₁∥q₂∥q₃∥ . . . ∥qⱼ∥ . . . ∥q_{Y}_{_{i(N)}}) Eq. 1

More specifically, the value of Q is expressed by 4 bits every time to send the query commands (for the QueryRep command, the value of Q incorporated in a previous command is used), the values of Q are concatenated and the concatenated bit streams are hashed to thereby produce the group key.

For example, when it is assumed that there are one hundred (100) of the tags 14 (N=100), and the number of query commands that are required to complete i-th inventory round becomes 325 (i.e., Yi(100)=325), then 325 number of the value of Q can be obtained, which amounts to 1,300 bits (i.e., 325×4 bits=1,300 bits). When hashing these bits, 160 bits can be obtained. If 128 bits are needed with a required algorithm, most significant 128 bits become Gi(100).

Next, in operation 303, the reader 10 establishes session keys with the tags 14. The session keys are established using the UII (Unique Item Identification) which is owned by each tag 14. To put it another way, after the reader 10 and the tags 14 generate the group key in accordance with the embodiment of the present invention, the reader 10 and the tags 14 establish the session keys using a following Equation 2.

Sᵢ₍ₜ₎=E_{G}_{_{i(N)}}(UII) Eq. 2

That is, after an arbitrary tag t generates a group key Gi(N) with the reader 10 in i-th inventory round, it uses the group key Gi(N) as an encryption key and a UII of its own as a target message to be encrypted in order to establish the session key with the reader 10. A resultant value that is subjected to the encryption operation is used as the session key Si(t) between the reader 10 and the tags 14.

The session key establishment method of the embodiment merely encrypts the UII of the tags by making use of the group key as an encryption key, and therefore, an efficient key establishment is accomplished without a separate key exchange protocol required in a conventional key establishment method.

The combinations of the each block of the block diagram and each operation of the flow chart accompanied by the present invention may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments. Therefore, the scope of protection of the present invention should be construed as defined in the following claims and changes, modifications and equivalents that fall within the technical idea of the present invention are intended to be embraced by the scope of the claims of the present invention.

What is claimed is:

1. A method for a key establishment in RFID system using an adaptive Q anti-collision algorithm, the method comprising:
generating group key between a reader and a number of tags using values of Q that are changed under the adaptive Q anti-collision algorithm; and
creating session keys between the reader and the tags using unique IDs of the respective tags.

2. The method of claim 1, wherein said generating a group key comprises:
concatenating the values of Q to produce concatenated bit streams; and
hashing the concatenated bit streams to generate the group key.

3. The method of claim 1, wherein said creating session keys comprises:
performing an encryption operation on the unique IDs wherein the group key is used as an encryption key.

4. The method of claim 1, wherein the group key and the session keys are updated and generated every inventory round.

5. The method of claim 1, wherein the RFID system is a passive RFID system that uses a 900 MHz frequency band.

6. The method of claim 1, wherein the group key is generated in an L2 data link layer.

7. The method of claim 1, wherein the session keys are generated in an L2 data link layer.
